(19) United States
(12) Patent Application Publication
(10) Pub. No.: US 2023/0327449 A1
(43) Pub. Date: Oct. 12, 2023

(54) Power conversion system

(71) Applicant: DARFON ELECTRONICS CORP., Taoyuan City (TW)

(72) Inventor: Wei-Lin Liu, Taoyuan City (TW)

(73) Assignee: DARFON ELECTRONICS CORP., Taoyuan City (TW)

(21) Appl. No.: 18/131,380

(22) Filed: Apr. 6, 2023

Related U.S. Application Data
(60) Provisional application No. 63/328,278, filed on Apr. 7, 2022.

(30) Foreign Application Priority Data
Mar. 29, 2023 (TW) 112111901

(51) Int. Cl. H02J 3/32; H02M 1/00; H02J 7/00; H02J 7/02

(52) U.S. Cl. CPC H02J 3/32; H02M 1/0009; H02J 7/0048; H02J 7/00712; H02J 7/02; H02J 2207/20; H02J 2300/24

(57) ABSTRACT

A microcontroller unit of a power conversion system (PCS) obtains a current charged ratio of a rechargeable battery according to a state-of-charge (SOC) signal received from the rechargeable battery, and obtains an output power of the PCS according to the voltage and current detected by a voltmeter-and-current meter of the PCS. When detecting mains off-grid, the microcontroller unit adjusts a frequency of an output alternating current of the power conversion system based on the output power and the current charged ratio of the charging battery, causing the frequency of the alternating current to switch between no less than three different frequencies. The greater current charged ratio of the charging battery, the lower the frequency the alternating current is switched to.

### BACKGROUND OF THE INVENTION

### 1. Field of the Invention

The present invention is related to a power conversion system (PCS), in particular to a power conversion system that can adjust the output AC frequency according to the charged ratio of a rechargeable battery.

### 2. Description of the Prior Art

Power conversion system (PCS) is a bidirectional power conversion inverter that can be used for on-grid and off-grid electrical power storage applications. The efficient operation of a power conversion system has always been an important issue in this technical field.

### SUMMARY OF THE INVENTION

A power conversion system of the present invention comprises an alternating current power port, a direct current power port, a voltmeter-and-current meter and a microcontroller unit. The direct current power port is coupled to a rechargeable battery. The voltmeter-and-current meter is coupled to the AC power port for detecting a voltage and a current output by the power conversion system from the AC power port. The microcontroller unit is for controlling an operation of the power conversion system and receiving a state-of-charge signal from the rechargeable battery. The microcontroller unit obtains a current charged ratio of the rechargeable battery according to the state-of-charge signal, and obtains the output power of the power conversion system according to the voltage and the current detected by the voltmeter-and-current meter. When the microcontroller unit detects an occurrence of mains off-grid, the microcontroller unit performs the following steps: determining whether the current charged ratio of the rechargeable battery is greater than a first predetermined ratio; when it is determined that the current charged ratio of the rechargeable battery is greater than the first predetermined ratio, adjusting a frequency of the alternating current output from the alternating current power port of the power conversion system, so that a photovoltaic inverter coupled to the AC power port stops outputting power; when it is determined that the current charged ratio of the rechargeable battery is less than the first predetermined ratio and greater than a second predetermined ratio, and the negative value of the output power is greater than a first predetermined power, increasing the frequency; when it is determined that the current charged ratio of the rechargeable battery is less than a third predetermined ratio, reducing the frequency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a power conversion system according to an embodiment of the present invention and the coupled mains, load, rechargeable battery, photovoltaic inverter, and solar panel.

FIG. 2 is a relationship diagram between the output power ratio of the photovoltaic inverter in FIG. 1 and the frequency of the alternating current output by the power conversion system.

FIG. 3A and FIG. 3B are flowcharts of the microcontroller unit in FIG. 1 controlling the power conversion system.

### DETAILED DESCRIPTION

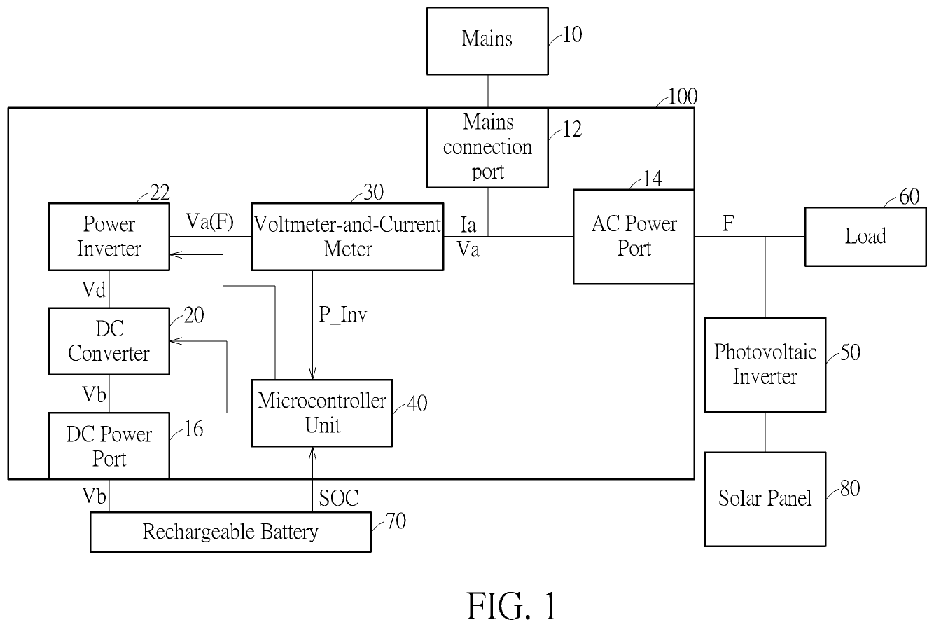

FIG. 1 is a functional block diagram of a power conversion system (PCS) according to an embodiment of the present invention and the coupled mains 10, a load 60, a rechargeable battery 70, a photovoltaic inverter (PV inverter) 50, and a solar panel 80. The PV inverter 50 converts the direct current power generated by the solar panel 80 to alternating current power, and feeds the converted alternating current into the load 60 and/or the power conversion system 100.

The power conversion system 100 includes a mains connection port 12, an AC power port 14, a DC power port 16, a voltmeter-and-current meter 30 and a microcontroller unit (MCU) 40. The power conversion system 100 can be connected to the mains 10 through the mains connection port 12 and receive power from the mains 10. The DC power port 16 is coupled to the rechargeable battery 7, and the power conversion system 100 can charge the rechargeable battery 70 through the DC power port 16 or receive power from the rechargeable battery 70. The voltmeter-and-current 30 is coupled to the AC power port 14 to detect the voltage Va and current Ia output from the AC power port 14 by the power conversion system 100. Wherein, the voltage Va and the current Ia are the AC voltage and the AC current respectively. The MCU 40 controls the operation of the power conversion system and receives a state-of-charge signal SOC from the rechargeable battery 70. Wherein, the MCU 40 can obtain the current charged ratio of the rechargeable battery 70 according to the state-of-charge signal SOC, and obtain the output power P_Inv of the power conversion system 100 according to the voltage Va and current Ia detected by the voltmeter 30. Wherein, when the output power P_Inv is positive, it means that the power conversion system 100 outputs power through the AC power port 14; and when the external output power P_Inv is negative, it means that the power conversion system 100 receives power from the outside through the AC power port 14.

The power conversion system 100 may further include a DC converter 20 and a power inverter 22. The DC converter 20 converts the DC voltage Vb output by the rechargeable battery 70 into a DC voltage Vd with different values, and the power inverter 22 converts the DC voltage Vd into an AC voltage Va.

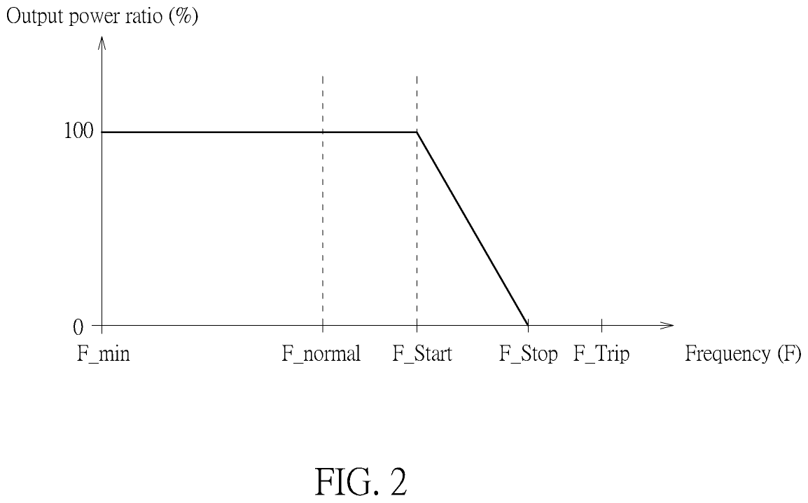

When the microcontroller unit 40 detects that the mains off-grid (for example: when the connection between the connection port 12 and the mains 10 is cut off or the mains 10 is powered off), the microcontroller unit 40 adjusts the frequency F of the AC power output by the power conversion system 100 from the AC power port 14, and controls the output power P_Inv output by the power conversion system 100. Please refer to FIG. 2. FIG. 2 is a relationship diagram between the output power ratio of the photovoltaic inverter 50 in FIG. 1 and the frequency F of the alternating current output by the power conversion system 100. The horizontal axis of FIG. 2 represents the frequency F of the AC power output by the power conversion system 100 from the AC power port 14, and the vertical axis of FIG. 2 represents the output power ratio of the photovoltaic inverter 50. The position marked 100 on the vertical axis in FIG. 2 indicates that the output of the photovoltaic inverter 50 is at the maximum value (i.e. 100%), and the position marked 0 on the vertical axis indicates that the output of the photovoltaic inverter 50 is stopped. Furthermore, when the frequency F is between F_Start and F_Stop, the output power ratio and the frequency F have a linear inverse relationship, that is, the larger the output power ratio at this time, the lower the AC frequency F will be. Wherein F_min<F_normal<F_Start<F_Stop, and F_min represents the minimum value of the frequency F of the alternating current output by the power conversion system 100, and F_normal is the frequency of the power conversion system 100 in general normal operation. The output power ratio corresponding to F_Start is equal to 100%, and the output power ratio corresponding to F_Stop is equal to 0%. Wherein, F_min may be referred to as “minimum frequency”, F_normal may be referred to as “normal frequency”, F_Start may be referred to as “start frequency”, and F_Stop may be referred to as “stop frequency”. The start frequency F_Start is, for example, 60 Hertz (Hz), and the stop frequency F_Stop is, for example, 60.5 Hertz (Hz). Furthermore, there is another cut-off frequency F_trip, which forces the photovoltaic inverter 50 to stop outputting power, so that the power conversion system 100 enters into over-frequency protection (F_Trip is, for example, 60.6 Hertz (Hz). Since the photovoltaic inverter 50 stops outputting power once the frequency F of the alternating current exceeds F_Trip, the frequency F_trip may be referred to as the “cut-off frequency”).

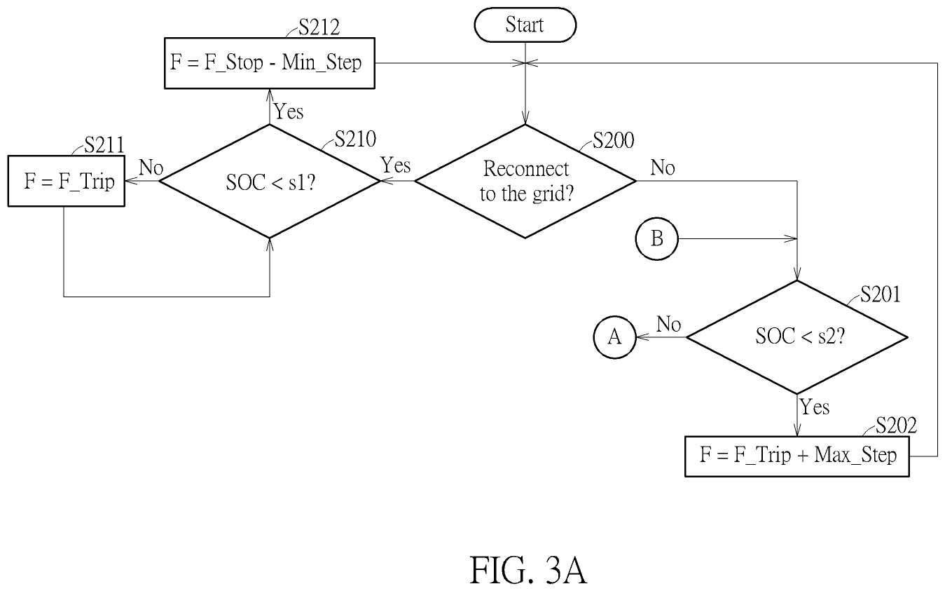

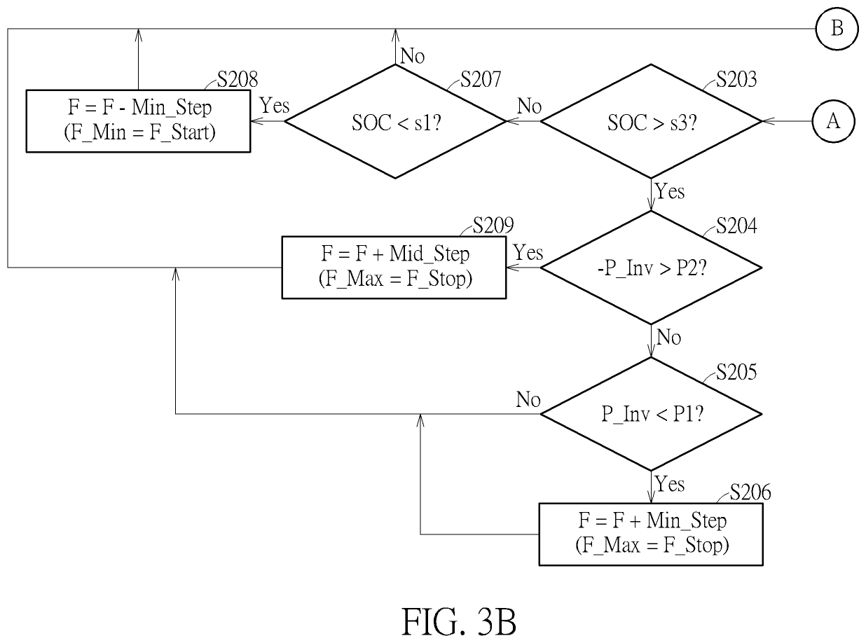

FIG. 3A and FIG. 3B are flowcharts of the control of the power conversion system 100 by the microcontroller unit 40 of FIG. 1. When the microcontroller unit 40 detects that the mains off-grid (for example: when the connection between the connection port 12 and the mains 10 is cut off or the mains 10 is powered off) or reconnected and feeding to the grid, the microcontroller unit 40 executes the process of FIG. 3A and FIG. 3B, and this process includes the following steps:
Step S200: the microcontroller unit 40 determines whether the power conversion system 100 is reconnected to the grid, wherein when the conversion system 100 is reconnected to the mains 10 or the photovoltaic inverter 50 starts to supply power; it means that the power conversion system 100 is reconnected to the grid. When the microcontroller unit 40 determines that the power conversion system 100 has not been reconnected to the grid, execute step S201; otherwise, execute step S210;
Step S201: the microcontroller unit 40 determines whether the current charged ratio of the rechargeable battery 70 is greater than a predetermined ratio S2 according to the state-of-charge signal SOC, wherein the predetermined ratio S2 may between 20% and 90%, and when the microcontroller unit 40 determines that the current charged ratio of the rechargeable battery 70 is greater than the predetermined ratio S2, execute step S202; otherwise, return to step S203;
Step S202: the micro-control unit 40 increases the frequency F of the alternating current output by the power conversion system 100 from the alternating current power supply port 14 to (F_Trip+Max_Step), so that the photovoltaic inverter 50 coupled to the alternating current power supply port 14 stops outputting power, and enters into over-frequency protection. Wherein F_Trip is, for example, 62 Hertz (Hz), and Max_step is, for example, 0.3 Hz. Furthermore, once the frequency F of the alternating current reaches above F_Trip, the photovoltaic inverter 50 stops outputting power, and the frequency F_Trip may be called a “cut-off frequency”. Therefore, when the frequency F of the alternating current is equal to (F_Trip+Max_step), it is more likely to ensure that the photovoltaic inverter 50 stops outputting power; furthermore, Max_Step can be equal to ((F_Stop−F_Start)/2), and F_Trip is greater than F_Stop; when the microcontroller unit 40 finishes executing step S202, it returns to step S200;
Step S203: the microcontroller unit 40 determines whether the current charged ratio of the rechargeable battery 70 is greater than the predetermined ratio S3 according to the state-of-charge signal SOC. Wherein, the predetermined ratio S3 is smaller than the predetermined ratio S2, and can range from 15% to 85%. When the microcontroller unit 40 determines that the current charged ratio of the rechargeable battery 70 is greater than the predetermined ratio S3, execute step S204; otherwise, execute step S207;
Step S204: the microcontroller unit 40 determines whether the negative value of the output power P_Inv (i.e. −P_Inv) is greater than the predetermined power P2. Wherein, when the negative value of the output power P_Inv is positive, it means that the power conversion system 100 receives power from the outside, and the predetermined power P2 is, for example, 1000 watts, but not limited thereto. When the microcontroller unit 40 does not determine that the negative value of the output power P_Inv is greater than the predetermined power P2, execute step S205; and when the microcontroller unit 40 determines that the negative value of the output power P_Inv is greater than the predetermined power P2, execute Step S209;
Step S205: the microcontroller unit 40 determines whether the output power P_Inv is less than the predetermined power P1. Wherein the predetermined power P1 is less than the predetermined power P2, and the predetermined power P1 is, for example, 500 watts, but not limited thereto. When it is determined that the output power P_Inv is less than the predetermined power P1, execute step S206; otherwise, return to step S201;
Step S206: the microcontroller unit 40 raises the frequency F by a predetermined value Min_Step (i.e. F=F+Min_Step), and return to step S201. Wherein, the predetermined value Min_Step may be equal to ((F_Stop−F_Start)/8), and the frequency F is adjusted up to F_Stop in this step, that is, the maximum value F_Max of the frequency F in this step is F_Stop. The function of step S206 is: when the current charged ratio of the rechargeable battery 70 is greater than the predetermined ratio S3, and the output power P_Inv is lower than the predetermined power P1, the output power of the photovoltaic inverter 50 is reduced by increasing the frequency F;
Step S207: the microcontroller unit 40 determines whether the current charged ratio of the rechargeable battery 70 is less than the predetermined ratio 51 according to the state-of-charge signal SOC. Wherein, the predetermined ratio 51 is smaller than the predetermined ratios S2 and S3, and can be between 10% and 80%. When the microcontroller unit 40 determines that the current charged ratio of the rechargeable battery 70 is smaller than the predetermined ratio 51, step S208 is executed; otherwise, return to step S201;
Step S208: the microcontroller unit 40 lowers the frequency F by a predetermined value Min_Step (i.e. F=F−Min_Step), and return to step S201; wherein, the lowest value of the frequency F is adjusted to F_Start in this step, that is, the minimum value F_min of the frequency F in this step is F_Start. The function of step S208 is: when the current charged ratio of the rechargeable battery 70 is less than the predetermined ratio 51, the output power of the photovoltaic inverter 50 is increased by decreasing the frequency F;
Step S209: the microcontroller unit 40 increases the frequency F by a predetermined value Mid_Step (i.e. F=F+Mid_Step), and returns to step S201; wherein, the predetermined value Mid_Step may be equal to ((F_Stop−F_Start)/4), and the frequency F is adjusted up to F_Stop in this step, that is, the maximum value F_Max of the frequency F in this step is F_Stop. The function of step S209 is: when the current charged ratio of the rechargeable battery 70 is greater than the predetermined ratio S3, and the power received by the power conversion system 100 from the outside is greater than the predetermined power P2, by increasing the frequency F, the output power of the photovoltaic inverter 50 is reduced;
Step S210: the microcontroller unit 40 determines whether the current charged ratio of the rechargeable battery 70 is less than the predetermined ratio 51 according to the state-of-charge signal SOC. If the microcontroller unit 40 determines that the current charged ratio of the rechargeable battery 70 is not less than the predetermined ratio 51, then execute step S211; otherwise, execute step S212;
Step S211: the microcontroller unit 40 sets the frequency F as the cut-off frequency F_Trip, so that the photovoltaic inverter 50 stops outputting power, enters over-frequency protection, and return to step S210; and
Step S212: the microcontroller unit 40 adjusts the frequency F to (F_Stop−Min_Step), and returns to step S200.

When the photovoltaic inverter 50 detects that the voltage or frequency exceeds the normal operating range, it starts protection (for example: overvoltage, under voltage, over frequency, under frequency, islanding . . . etc.), and then no longer outputs power and feeds to the grid, at this time, the microcontroller unit 40 determines whether the photovoltaic inverter 50 has tripped, and adjusts the AC output frequency F of the power conversion system 100 according to the state to determine whether the photovoltaic inverter 50 can be reconnected and fed to the grid. If the photovoltaic inverter 50 detects that the voltage and frequency of the mains terminal meet the normal operating range, it determines that the condition for reconnecting to the grid is met, and the photovoltaic inverter 50 counts a certain number of seconds (for example: 300 seconds as specified by grid-connected regulations) and will be fed into the grid output.

In the present invention, when the frequency F is between F_Start and F_Stop, the output power ratio and the frequency F present a linear inverse relationship, as shown in FIG. 2. Therefore, compared with the general two-stage control method (i.e. the photovoltaic inverter outputs in a full output (100%) or no output (0%) mode), the microcontroller unit 40 can adjust the output power of the photovoltaic inverter 50 in a multi-stage manner, and avoid the instability of the power supply system caused by the instantaneous full output (100%) or no output (0%) of the photovoltaic inverter.

Furthermore, according to FIG. 2 and the above mentioned steps S203 to S208, when the microcontroller unit 40 detects the mains off-grid, the microcontroller unit 40 limits the frequency F of the AC output from the AC power port 10 within a predetermined range between F_Start and F_Stop, and within this predetermined range, the output power of the photovoltaic inverter 50 is negatively correlated with the frequency F of the alternating current.

When the microcontroller unit 40 of the present invention detects that the mains off-grid, it causes the power conversion system 100 to output the AC frequency F, and then induces the photovoltaic inverter 50 not to enter the islanding protection and can generate power and feed to the grid, its energy can be supplied to the load 60 and the power conversion system 100, and the microcontroller unit 40 dynamically adjusts the frequency of the alternating current output by the power conversion system 100 according to the current charged ratio of the rechargeable battery 70 and the positive or negative magnitude of the output power P_Inv, thus the overall power flow can be efficiently controlled.

Those skilled in the art will readily observe that numerous modifications and alterations of the device and method may be made while retaining the teachings of the invention. Accordingly, the above disclosure should be construed as limited only by the metes and bounds of the appended claims.

### DESCRIPTION OF REFERENCE NUMERALS

10: Mains
12: Mains connection port
14: AC Power Port
16: DC Power Port
20: DC Converter
22: Power Inverter
30: Voltmeter-and-Current Meter
40: Microcontroller Unit
50: Photovoltaic Inverter
60: Load
70: Rechargeable Battery
80: Solar Panel
100: Power Conversion System
F: Frequency
F_min: Minimum Frequency
F_normal: Normal Frequency
F_Start: Start Frequency
F_Stop: Stop Frequency
F_Trip: Cut-off Frequency
Ia: Current
P_Inv: Output Power
Va: Voltage
Vb, Vd: DC Voltage
SOC: State-of-Charge Signal
S200 to S212: Steps

What is claimed is:

1. A power conversion system (PCS) comprising:
an alternating current (AC) power port;
a direct current (DC) power port coupled to a rechargeable battery;
a voltmeter-and-current meter coupled to the AC power port for detecting a voltage and a current output by the power conversion system from the AC power port;
a microcontroller unit (MCU) for controlling an operation of the power conversion system and receiving a state-of-charge (SOC) signal from the rechargeable battery;
wherein the microcontroller unit obtains a current charged ratio of the rechargeable battery according to the state-of-charge signal, and obtains the output power of the power conversion system according to the voltage and the current detected by the voltmeter-and-current meter; and
wherein when detecting mains off-grid, the microcontroller unit performs the following steps:
when determining that the current charged ratio of the rechargeable battery is greater than a first predetermined ratio, a frequency of an alternating current output by the power conversion system from the alternating current power port is adjusted to a first frequency, so that a photovoltaic (PV) inverter coupled to the AC power port stops outputting power.
when determining that the current charged ratio of the rechargeable battery is less than the first predetermined ratio and greater than a second predetermined ratio, and the negative value of the output power is greater than a first predetermined power, the frequency of the alternating current output by the alternating current power supply port is increased by a first predetermine value; and
when determining that the current charged ratio of the rechargeable battery is less than a third predetermined ratio, the frequency of the alternating current output by the alternating current power port is reduced by a second predetermined value.

2. The power conversion system of claim 1, wherein when determining that the current charged ratio of the rechargeable battery is less than the first predetermined ratio and greater than a second predetermined ratio, the negative value of the output power is not greater than the first predetermined power, and the output power is less than the second predetermined power, the frequency of the alternating current output by the alternating current power supply port is increased by a third predetermine value.

3. The power conversion system of claim 1, wherein when the second predetermined value is equal to the third predetermined value.

4. The power conversion system of claim 1, wherein when detecting the mains off-grid, and determining the negative value of the external power is not greater than the first predetermined power, the microcontroller unit limits the frequency of the AC output from the AC power port within a predetermined range.

5. The power conversion system of claim 4, wherein when the frequency of the alternating current output by the alternating current power port is within the predetermined range, the output power of the photovoltaic inverter is negatively correlated with the frequency of the alternating current.

6. The power conversion system of claim 1, wherein the first predetermined ratio is larger than the second predetermined ratio and the second predetermined ratio is larger than the third predetermined ratio.
